(19) United States
(12) Patent Application Publication
(10) Pub. No.: US 2008/0292784 A1
(43) Pub. Date: Nov. 27, 2008

(54) Method for Metallizing Liquid Crystal and Polymer

(76) Inventor: Steven Lee Dutton, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/123,323

(22) Filed: May 19, 2008

Related U.S. Application Data
(60) Provisional application No. 60/938,997, filed on May 18, 2007.

(51) Int. Cl. B05D 5/12

(52) U.S. Cl. 427/98.9

(57) ABSTRACT

A method for making printed circuits and printed circuit boards which utilizes a process for forming a thin metal layer, such as a copper layer, on underlying substrates such as a liquid crystalline polymer material. Forming such a thin metal layer on the surface of the substrate enables fine line imaging for forming printed circuits and printed circuit boards. The process includes providing a metallized substrate, removing the metal from the substrate, vacuum baking the substrate, dipping the substrate in permanganate solution, rinsing the substrate with water, neutralizing the substrate, subjecting the substrate to an electroless copper procedure and plating the substrate with copper.

### CROSS-REFERENCE TO RELATED APPLICATIONS

This application claims priority to provisional patent application having Ser. No. 60/938,997, filed May 18, 2007, which is herein incorporated in its entirety.

### FIELD OF INVENTION

This invention relates, generally, to a method for metallizing liquid crystalline polymer materials and, in particular, to a method for adding metal to bare liquid crystalline polymer materials.

### BACKGROUND OF THE INVENTION

Prior art applications typically use a copper cladded liquid crystalline polymer material to create printed circuits and printed circuit boards. For example, one example of a prior art process for forming printed circuits includes the steps of creating a CAD/CAM design, sending data relating to the design to a photo plotter, photo plotting to a silver halide polyester film, developing an image from the sent data, creating intermediate tools, scrubbing or cleaning a metallized substrate for imaging, such as a copper cladded liquid crystalline polymer material, coating the substrate with a dry film, imaging the substrate with the design, developing the image, etching the image, and then stripping the remaining dry film. This prior art process requires several steps and has limitations on the imaging, developing, and etching of fine line images. With this process, fine line imaging can be consistently performed down to 0.003 inches. However, imaging of much finer lines creates a problem and is inconsistent when using this prior art process. The copper cladding on the liquid crystalline polymer is sometimes too thick in order to image fine lines for particular applications. In addition, because the substrate comprises copper adhered to a liquid crystalline polymer material, processing of the copper cladded substrate has inherent issues with undercutting and rough edges which can create “lossy” issues for radio frequency applications. “Lossy” issues occur when any rough protrusions or undercutting act like small antennas and the signal travel speed is thereby reduced or lost during high frequency applications. Many applications for printed circuits and printed circuit boards require smooth images and very thin copper.

Accordingly, there is a need for a new method for making printed circuits and printed circuit boards which enables a substrate to be coated with a very thin layer of metal such as copper in order to facilitate fine line imaging without the inherent problems seen in the prior art processes.

### SUMMARY OF THE INVENTION

The present invention is directed to a method for making printed circuits and printed circuit boards which utilizes a process for forming a thin metal layer, such as a copper layer, on underlying substrates such as a liquid crystalline polymer material. Forming such a thin metal layer on the surface of the substrate enables fine line imaging for forming printed circuits and printed circuit boards which is finer and more consistent than fine line imaging performed with prior art processes.

In one exemplary embodiment, a method for metallizing a substrate such as a liquid crystalline polymer substrate includes the steps of providing a copper cladded liquid crystalline polymer material, removing the clad copper, vacuum baking the substrate, dipping the substrate in a permanganate solution, rinsing the substrate with water, subjecting the substrate to another water rinse, neutralizing the substrate in a neutralizing solution, water rinsing the neutralized substrate, subjecting the neutralized substrate to a second water rinse, subjecting the substrate to an electroless copper procedure, and then plating the substrate with a full copper layer or a copper pattern. Any type of electroless copper procedures and copper plating procedures well known in the art may be used.

Another exemplary method of metallizing a substrate such as a liquid crystalline polymer material with a thin metal such as copper includes the same steps described above with reference to the first exemplary embodiment in addition to a sulfuric acid process added to that embodiment. In particular, after vacuum baking the substrate subsequent to removing clad copper from the substrate, all or part of the substrate is dipped in 96% sulfuric acid heated to 120 to 140 degrees Fahrenheit for approximately 2 to 4 minutes. The substrate is then rinsed prior to dipping the substrate in the permanganate solution.

### BRIEF DESCRIPTION OF THE DRAWINGS

The present invention will hereinafter be described in conjunction with the appended drawing figures, wherein like numerals denote like elements and:

FIG. 1 is a flow chart depicting an exemplary embodiment of the method of the present invention for metallizing substrates with a thin metal layer; and

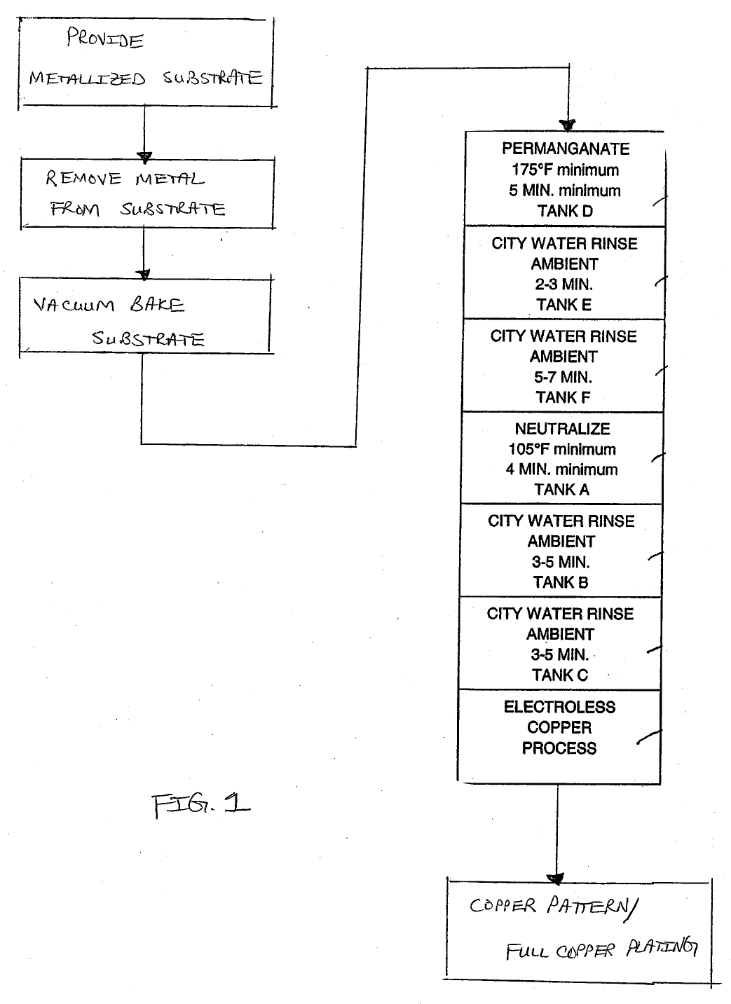

FIG. 2 is a flow chart depicting another exemplary embodiment of a method of the present invention for metallizing substrates with a thin metal layer.

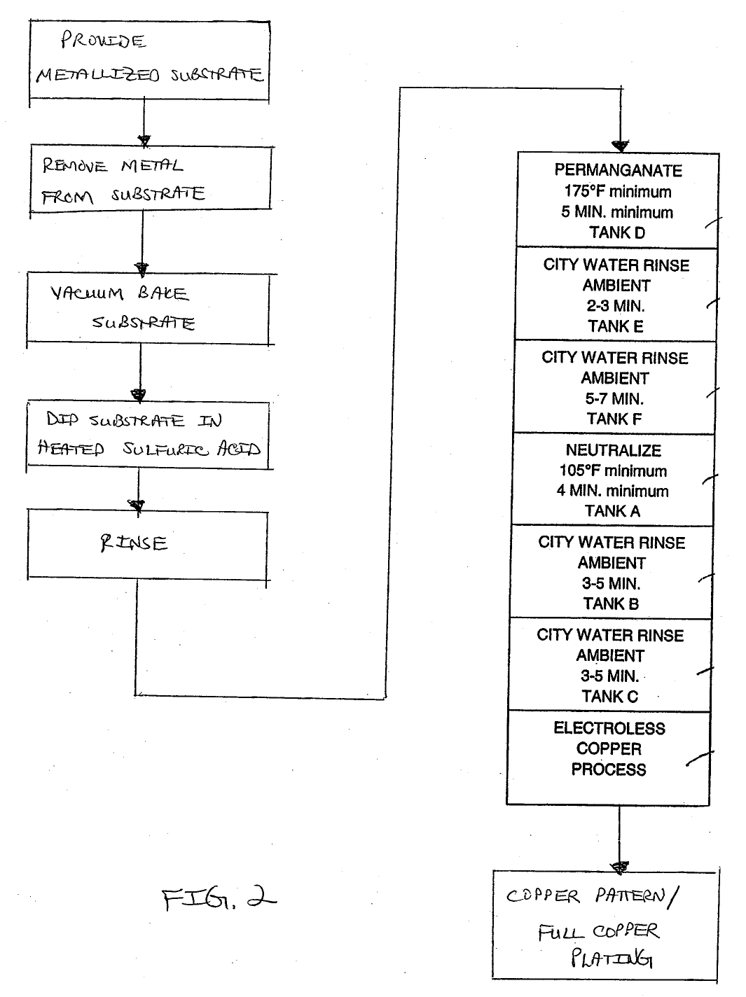

1. A method for making printed circuits comprising the steps of:
providing a metallized substrate;
removing the metal from the substrate;
vacuum baking the substrate;
dipping the substrate in a permanganate solution;
rinsing the substrate with water;
neutralizing the substrate in a neutralizing solution;
subjecting the substrate to an electroless copper procedure; and
plating the substrate with copper.
